(19) United States
(12) Patent Application Publication
(10) Pub. No.: US 2026/0020122 A1
(43) Pub. Date: Jan. 15, 2026

(54) COLOR TEMPERATURE-ADJUSTABLE LAMP DEVICE

(71) Applicant: SAVANT TECHNOLOGIES LLC, East Cleveland, OH (US)

(72) Inventors: Tianci ZHOU, Shanghai (CN); Zhichao LIU, Shanghai (CN); Chengbin LIU, Shanghai (CN)

(73) Assignee: SAVANT TECHNOLOGIES LLC, East Cleveland, OH (US)

(21) Appl. No.: 19/193,292

(22) Filed: Apr. 29, 2025

(30) Foreign Application Priority Data
May 29, 2024 (CN) 2024212020630

(51) Int. Cl. H05B 45/20; H05B 45/34; H05B 45/46; H05B 45/48; H05B 47/155

(52) U.S. Cl. CPC H05B 45/20; H05B 45/34; H05B 45/46; H05B 45/48; H05B 47/155

(57) ABSTRACT

Provided is a color temperature-adjustable lamp device that includes a first LED lamp assembly, having LEDs and light emitted therefrom of a first color temperature, a second LED lamp assembly with light emitted therefrom of a second color temperature, and the second color temperature is different from the first color temperature, a color temperature adjustment portion, connected in series with one of the lamp assemblies, the color temperature adjustment portion includes a diode, an LED and a voltage regulator tube, and a manual switch assembly that controls the turning on and off of the lamp assemblies, and after connecting the color temperature adjustment portion in series with one of the lamp assemblies, a light-emitting assembly is formed together by a first lamp string and a second lamp string, and the light-emitting assembly is connected between a voltage source end and a grounding end.

### CROSS-REFERENCE TO RELATED APPLICATIONS

This application claims priority to Chinese Patent Application Serial Number 2024212020630, filed May 29, 2024, which is herein incorporated by reference.

### TECHNICAL FIELD

The present disclosure relates to the field of lamps, and more particularly, to a color temperature-adjustable lamp device.

### BACKGROUND

In modern life, lamp lighting has become an indispensable part of people's life, and color temperature adjustment of lamps provides diversified choices and comfort of lighting for users. By adjusting the color temperature of a lamp, a user can create an ideal atmosphere for the working or living space thereof according to personal preferences and requirements. In addition, selecting a suitable color temperature according to different scenarios can not only improve the quality of life, but also reduce energy consumption, thereby realizing green lighting.

In the prior art, the driving current in a high-color-temperature LED string is significantly reduced by connecting resistors in series with the high-color-temperature LED string of the lamp, such that the high color temperature of the high-color-temperature LED string of the lamp is mixed with low color temperature of a low-color-temperature LED string of the lamp, to obtain an intermediate color temperature between the high color temperature and the low color temperature. However, in such a manner of adjusting the color temperature, heat dissipation caused by the resistors in the high-color-temperature LED string of the lamp (especially when there is only a single high-color-temperature LED in the high-color-temperature LED string) is non-negligible, and an appropriate thermal management measure needs to be taken, which necessarily increases the size or manufacturing costs of the lamp.

### SUMMARY

In order to overcome the described technical problems, the present disclosure provides a color temperature-adjustable lamp device, in which by connecting a color temperature adjustment portion comprising at least one of a diode, an LED and a voltage regulator tube in series with LED lamp assemblies having different color temperatures of a lamp, and by controlling the turning-on and turning-off of the LED lamp assemblies by means of a manual switch assembly, adjustment of multiple color temperatures of the lamp device is achieved while avoiding the introduction of significant heat dissipation in the LED lamp assemblies.

According to embodiments of the present disclosure, provided is a color temperature-adjustable lamp device, comprising: a first LED lamp assembly, having one or more LEDs, wherein light emitted by the first LED lamp assembly has a first color temperature; a second LED lamp assembly, having LEDs, the number of which is the same as the number of the LEDs in the first LED lamp assembly, wherein light emitted by the second LED lamp assembly has a second color temperature, and the second color temperature is different from the first color temperature; a color temperature adjustment portion, connected in series with at least one of the first LED lamp assembly and the second LED lamp assembly, the color temperature adjustment portion comprising at least one of a diode, an LED and a voltage regulator tube; and a manual switch assembly, for controlling the turning-on and turning-off of the first LED lamp assembly and the second LED lamp assembly, wherein after connecting the color temperature adjustment portion in series with at least one of the first LED lamp assembly and the second LED lamp assembly, a light-emitting assembly is formed together by a formed first lamp string where the first LED lamp assembly is located and a formed second lamp string where the second LED lamp assembly is located, and the light-emitting assembly is connected between a voltage source end and a grounding end.

By connecting a color temperature adjustment portion comprising at least one of a diode, an LED and a voltage regulator tube in series with at least one of the first LED lamp assembly and the second LED lamp assembly of the lamp, and by controlling the turning-on and turning-off of the LED lamp assemblies by means of the manual switch assembly, adjustment of multiple color temperatures of the lamp device is achieved while avoiding the introduction of significant heat dissipation in the LED lamp assemblies.

In the color temperature-adjustable lamp device according to the present disclosure, the color temperature adjustment portion comprises: a first color temperature adjustment portion, connected between the second LED lamp assembly and the grounding end.

By the described manner, a specific connection manner between the color temperature adjustment portion and one of the first LED lamp assembly and the second LED lamp assembly is provided.

In the color temperature-adjustable lamp device according to the present disclosure, the manual switch assembly comprises: a first manual switch assembly, connected between the first LED lamp assembly and the grounding end; and a second manual switch assembly, connected between the first color temperature adjustment portion and the grounding end.

By the described manner, the turning-on and turning-off of the first LED lamp assembly and the second LED lamp assembly are controlled by the provided first manual switch assembly and second manual switch assembly, a lamp device capable of achieving adjustment between a plurality of color temperatures can be realized.

In the color temperature-adjustable lamp device according to the present disclosure, the first LED lamp assembly comprises one first LED string or two or more first LED strings connected in parallel, each of the first LED strings comprising one or more first LEDs connected in series between the voltage source end and the grounding end, the first LEDs having the first color temperature; and the first manual switch assembly comprises one or more first switches, each of the first switches being connected between each of the first LED strings and the grounding end.

By the described manner, a specific configuration of the first LED lamp assembly and the first manual switch assembly and a connection relationship therebetween are provided.

In the color temperature-adjustable lamp device according to the present disclosure, the second LED lamp assembly comprises one second LED string or two or more second LED strings connected in parallel, each of the second LED strings comprising one or more second LEDs connected in series between the voltage source end and the grounding end, the second LEDs having the second color temperature; the first color temperature adjustment portion comprises one or more third LEDs connected between the second LED string and the grounding end on each of the second LED strings; and the second manual switch assembly comprises one or more second switches, and each of the second switches is connected between the third LEDs and the grounding end on each of the second LED strings.

By the described manner, a specific configuration of the second LED lamp assembly, the first color temperature adjustment portion and the second manual switch assembly and a connection relationship therebetween are provided.

In the color temperature-adjustable lamp device according to the present disclosure, the second LED lamp assembly comprises one second LED string or two or more second LED strings connected in parallel, each of the second LED strings comprising one or more second LEDs connected in series between the voltage source end and the grounding end, the second LEDs having the second color temperature; the first color temperature adjustment portion comprises one or more first diodes connected between the second LED string and the grounding end on each of the second LED strings; and the second manual switch assembly comprises one or more second switches, and each of the second switches is connected between the first diodes and the grounding end on each of the second LED strings.

By the described manner, another specific configuration of the second LED lamp assembly, the first color temperature adjustment portion and the second manual switch assembly and a connection relationship therebetween are provided.

In the color temperature-adjustable lamp device according to the present disclosure, the first LED lamp assembly comprises two or more first LED strings connected in parallel, each of the first LED strings comprising one or more first LEDs connected in series between the voltage source end and the grounding end, the first LEDs having the first color temperature; and the first manual switch assembly comprises one first switch, wherein the first switch is connected between a first common node of the two or more first LED strings and the grounding end, and the first common node is located between the voltage source end and the grounding end.

By the described manner, another specific configuration of the first LED lamp assembly and the first manual switch assembly and a connection relationship therebetween are provided.

In the color temperature-adjustable lamp device according to the present disclosure, the second LED lamp assembly comprises two or more second LED strings connected in parallel, each of the second LED strings comprising one or more second LEDs connected in series between the voltage source end and the grounding end, the second LEDs having the second color temperature; the first color temperature adjustment portion comprises one or more third LEDs connected between a second common node of the two or more second LED strings and the grounding end, wherein the second common node is located between the voltage source end and the grounding end; and the second manual switch assembly comprises one second switch, the second switch being connected between the third LEDs and the grounding end.

By the described manner, another specific configuration of the second LED lamp assembly, the first color temperature adjustment portion and the second manual switch assembly and a connection relationship therebetween are provided.

In the color temperature-adjustable lamp device according to the present disclosure, the second LED lamp assembly comprises two or more second LED strings connected in parallel, each of the second LED strings comprising one or more second LEDs connected in series between the voltage source end and the grounding end, the second LEDs having the second color temperature; the first color temperature adjustment portion comprises one or more diodes connected between a second common node of the two or more second LED strings and the grounding end, wherein the second common node is located between the voltage source end and the grounding end; and the second manual switch assembly comprises one second switch, the second switch being connected between the diodes and the grounding end.

By the described manner, another specific configuration of the second LED lamp assembly, the first color temperature adjustment portion and the second manual switch assembly and a connection relationship therebetween are provided.

In the color temperature-adjustable lamp device according to the present disclosure, the color temperature adjustment portion further comprises: a second color temperature adjustment portion, connected between the first LED lamp assembly and the grounding end, the second color temperature adjustment portion comprising one or more fourth LEDs respectively connected between each of the first LED strings and the grounding end, wherein the manual switch assembly further comprises one or more third switches, and each of the third switches is connected between the fourth LEDs and the grounding end on each of the first LED strings.

By the described manner, the second color temperature adjustment portion and the switches are further connected in the first LED lamp assembly, a lamp device capable of achieving adjustment between a plurality of color temperatures can be realized.

In the color temperature-adjustable lamp device according to the present disclosure, the color temperature adjustment portion further comprises: a second color temperature adjustment portion, connected between the first LED lamp assembly and the grounding end, the second color temperature adjustment portion comprising one or more second diodes respectively connected between each of the first LED strings and the grounding end, wherein the manual switch assembly further comprises one or more third switches, and each of the third switches is connected between the second diodes and the grounding end on each of the first LED strings.

By the described manner, another lamp device capable of achieving adjustment between a plurality of color temperatures is provided.

In the color temperature-adjustable lamp device according to the present disclosure, the manual switch assembly further comprises one or more fourth switches, each of the fourth switches being connected between a node between the second LED string and the third LEDs and the grounding end on each of the second LED strings.

By the described manner, another lamp device capable of achieving adjustment between a plurality of color temperatures is provided.

In the color temperature-adjustable lamp device according to the present disclosure, the color temperature adjustment portion further comprises: a second color temperature adjustment portion, connected between the first LED lamp assembly and the grounding end, wherein the second color temperature adjustment portion comprises one or more fourth LEDs connected between the first common node of the two or more first LED strings and the grounding end, the fourth LEDs having the first color temperature, wherein the manual switch assembly further comprises one third switch, the third switch being connected between the fourth LEDs and the grounding end.

By the described manner, another lamp device capable of achieving adjustment between a plurality of color temperatures is provided.

In the color temperature-adjustable lamp device according to the present disclosure, the color temperature adjustment portion further comprises: a second color temperature adjustment portion, connected between the first LED lamp assembly and the grounding end, wherein the second color temperature adjustment portion comprises one or more second diodes connected between the first common node of the two or more first LED strings and the grounding end, wherein the manual switch assembly further comprises one third switch, the third switch being connected between the second diodes and the grounding end.

By the described manner, another lamp device capable of achieving adjustment between a plurality of color temperatures is provided.

In the color temperature-adjustable lamp device according to the present disclosure, the manual switch assembly further comprises a fourth switch, the fourth switch being connected between the second common node of the second LED strings and the grounding end.

By the described manner, another lamp device capable of achieving adjustment between a plurality of color temperatures is provided.

### BRIEF DESCRIPTION OF THE DRAWINGS

The drawings illustrated herein are used for providing further understanding of the present disclosure and constitute a part of the present disclosure, and the illustrative embodiments of the present disclosure and illustrations thereof are used for explaining the present disclosure, rather than constituting inappropriate limitation on the present disclosure. In the drawings:

FIG. 1 is a circuit diagram illustrating a color temperature-adjustable lamp device according to embodiments of the present disclosure.

FIG. 2 is a circuit diagram illustrating a first modification example of a color temperature-adjustable lamp device according to embodiments of the present disclosure.

FIG. 3 is a circuit diagram illustrating a second modification example of a color temperature-adjustable lamp device according to embodiments of the present disclosure.

FIG. 4 is a circuit diagram illustrating a third modification example of a color temperature-adjustable lamp device according to embodiments of the present disclosure.

FIG. 5 is a circuit diagram illustrating a fourth modification example of a color temperature-adjustable lamp device according to embodiments of the present disclosure.

### DETAILED DESCRIPTION OF THE EMBODIMENTS

In order to enable a person skilled in the art to understand the solutions of the present disclosure better, hereinafter, the technical solutions in the embodiments of the present disclosure will be described clearly and thoroughly with reference to the accompanying drawings of embodiments of the present disclosure. Obviously, the embodiments as described are only some of embodiments of the present disclosure, and are not all the embodiments. On the basis of the embodiments in the present disclosure, all other embodiments obtained by a person of ordinary skill in the art without any inventive effort shall all fall within the scope of protection of the present disclosure.

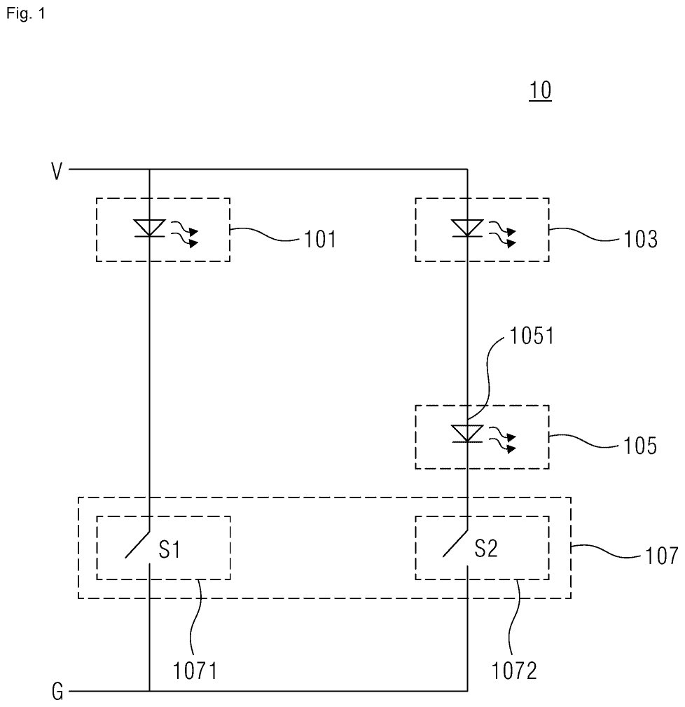

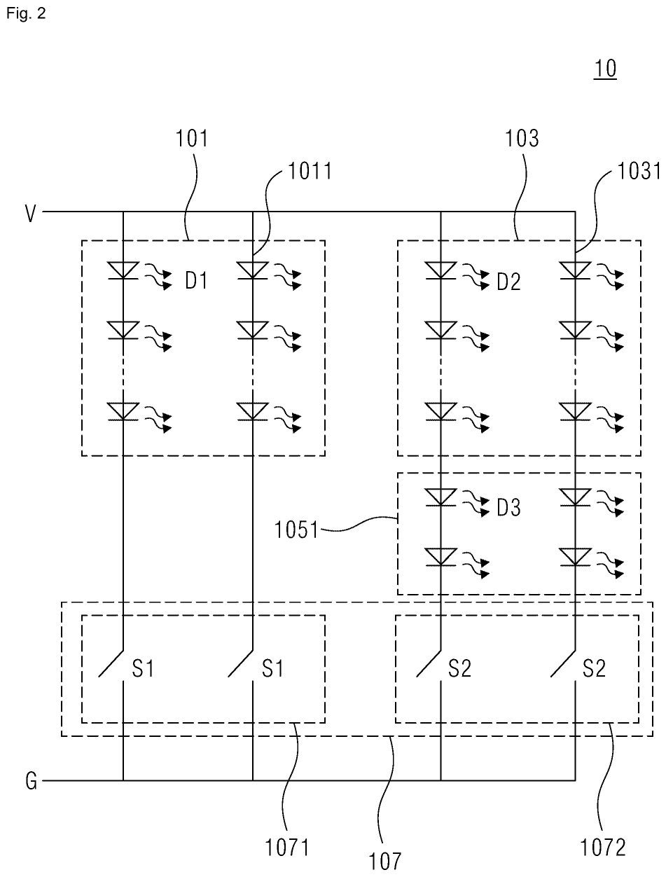

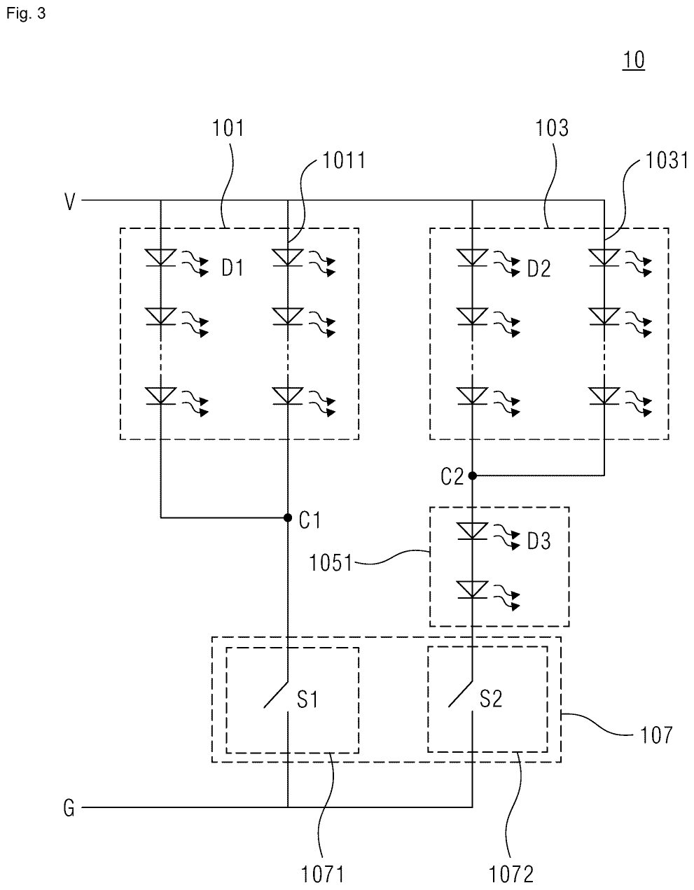

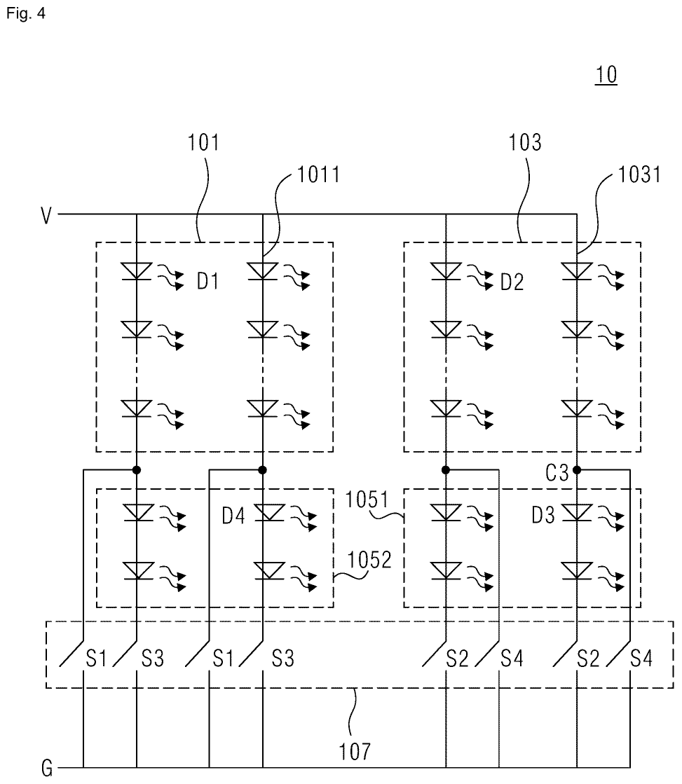

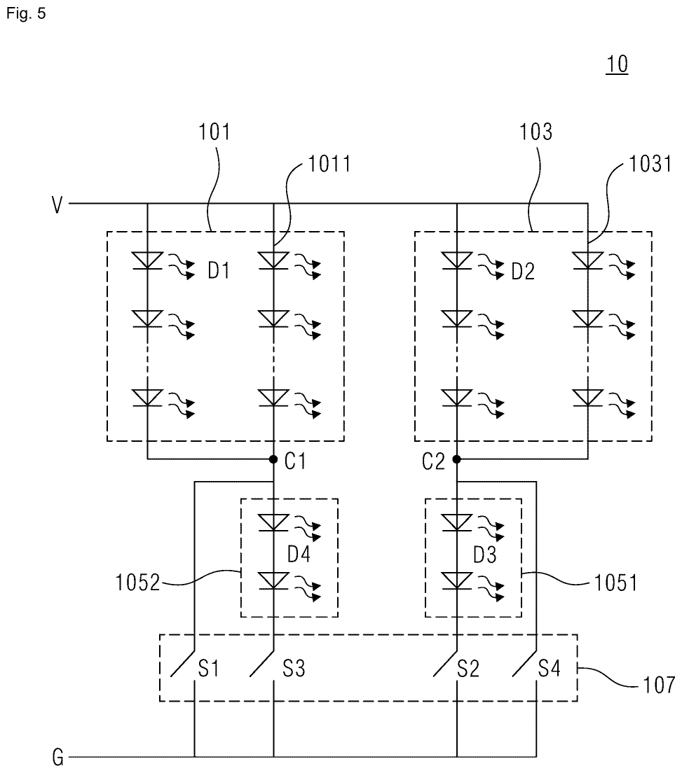

According to embodiments of the present disclosure, provided is color temperature-adjustable lamp device. FIG. 1 is a circuit diagram illustrating a color temperature-adjustable lamp device according to embodiments of the present disclosure; FIG. 2 is a circuit diagram illustrating a first modification example of a color temperature-adjustable lamp device according to embodiments of the present disclosure; FIG. 3 is a circuit diagram illustrating a second modification example of a color temperature-adjustable lamp device according to embodiments of the present disclosure; FIG. 4 is a circuit diagram illustrating a third modification example of a color temperature-adjustable lamp device according to embodiments of the present disclosure; and FIG. 5 is a circuit diagram illustrating a fourth modification example of a color temperature-adjustable lamp device according to embodiments of the present disclosure. Hereinafter, the color temperature-adjustable lamp device according to embodiments of the present disclosure is described in conjunction with FIGS. 1-5.

As shown in FIG. 1, the color temperature-adjustable lamp device 10 according to embodiments of the present disclosure comprises a first LED lamp assembly 101, a second LED lamp assembly 103, a color temperature adjustment portion 105 and a manual switch assembly 107. In order to facilitate understanding of the basic principle of the present disclosure, in FIG. 1, the first LED lamp assembly, the second LED lamp assembly, the color temperature adjustment portion, and the manual switch assembly are shown in a minimum number. However, the present disclosure is not limited thereto, and the arrangement and number of the described components may be as shown in the modification examples as shown in FIGS. 2-5, but are also not limited to these modifications, and may be arranged as required.

The first LED lamp assembly 101 has one or more LEDs. Light emitted by the first LED lamp assembly 101 has a first color temperature. For example, FIG. 1 shows that the first LED lamp assembly 101 comprises an LED with a color temperature of 3000K.

The second LED lamp assembly 103 has the same number of LEDs as the number of the LEDs in the first LED lamp assembly 101. Light emitted by the second LED lamp assembly 103 has a second color temperature, and the second color temperature is different from the first color temperature. For example, FIG. 1 shows that the second LED lamp assembly 103 comprises an LED with a color temperature of 6500K.

The color temperature adjustment portion 105 is connected in series with at least one of the first LED lamp assembly 101 and the second LED lamp assembly 103. The color temperature adjustment portion 105 may comprise at least one of a diode, an LED, and a voltage regulator tube. For example, FIG. 1 shows that the color temperature adjustment portion 105 comprises a first color temperature adjustment portion 1051, wherein the first color temperature adjustment portion 1051 is connected in series between the second LED lamp assembly 103 and a grounding end G, and comprises an LED with a color temperature of 6500K.

Optionally, instead of LED, the first color temperature adjustment portion 1051 can comprise a diode or a voltage regulator tube connected in series between the second LED lamp assembly 103 and the grounding end G.

The manual switch assembly 107 controls the turning-on and turning-off of the first LED lamp assembly 101 and the second LED lamp assembly 103, so as to adjust the color temperature of the lamp device 10. For example, FIG. 1 shows that the manual switch assembly 107 comprises a first manual switch assembly 1071 and a second switch assembly 1072. The first manual switch assembly 1071 is connected between the first LED lamp assembly 101 and the grounding end G, and the second manual switch assembly 1072 is connected between the first color temperature adjustment portion 1051 and the grounding end G. For example, in FIG. 1, a case in which the first manual switch assembly 1071 only comprises one first switch S1 and the second manual switch assembly 1072 only comprises one second switch S2 is shown, but the present disclosure is not limited thereto, and the number of the first switches and the number of the second switches may be set according to requirements.

After connecting the color temperature adjustment portion 105 in series with at least one of the first LED lamp assembly 101 and the second LED lamp assembly 103, a light-emitting assembly is formed together by a formed first lamp string where the first LED lamp assembly 101 is located and a formed second lamp string where the second LED lamp assembly 103 is located, and the light-emitting assembly is connected between a voltage source end and the grounding end. For example, as shown in FIG. 1, a second lamp string formed by connecting the first color temperature adjustment portion 1051 and the second LED lamp assembly 103 in series and the first lamp string where the first LED lamp assembly 101 is located together form the light-emitting assembly, and the light-emitting assembly is connected between the voltage source end V and the grounding end G.

Hereinabove, FIG. 1 only shows the situation that the first LED lamp assembly 101 only comprises one LED string and the LED string only comprises one LED, the second LED lamp assembly 103 only comprises one LED string and the LED string only comprises one LED, the first manual switch assembly 1071 only comprises one first switch S1, the second manual switch assembly 1072 only comprises one second switch S2 and the first color temperature adjustment portion 1051 only comprises one LED, however, the present disclosure is not limited thereto. The first LED lamp assembly 101 and the second LED lamp assembly 103 have the same number of LEDs, but a voltage difference is generated between turning-on voltages of the two. In the present invention, by adding the color temperature adjustment portion 1051, current distribution on the two strings of LED lamp assemblies is changed, thereby adjusting the color temperature.

FIG. 2 is a circuit diagram illustrating a first modification example of a color temperature-adjustable lamp device according to embodiments of the present disclosure.

In the first modification example, the first LED lamp assembly 101 can comprise one first LED string or two or more first LED strings 1011 connected in parallel. For example, FIG. 2 shows that the first LED lamp assembly 101 comprises two first LED strings 1011 connected in parallel, but the present disclosure is not limited thereto; the first LED lamp assembly 101 may comprise one first LED string or two or more first LED strings 1011 connected in parallel. Each of the first LED strings 1011 comprises one or more first LEDs D1 connected in series between the voltage source end V and the grounding end G. For example, FIG. 2 shows that each first LED string 1011 comprises three or more first LEDs connected in series. The first LEDs have the first color temperature of, for example, 3000K.

In the first modification example, the first manual switch assembly 1071 may comprise one or more first switches S1. For example, FIG. 2 shows that the first manual switch assembly 1071 comprises two first switches S1. Each of the first switches S1 is connected between each of the first LED strings 1011 and the grounding end G.

In the first modification example, the second LED lamp assembly 103 can comprise one second LED string or two or more second LED strings 1031 connected in parallel. For example, FIG. 2 shows that the second LED lamp assembly 103 comprises two second LED strings 1031 connected in parallel, but the present disclosure is not limited thereto; the second LED lamp assembly 103 may comprise one second LED string or two or more second LED strings 1031 connected in parallel. Each of the second LED strings 1031 comprises one or more second LEDs D2 connected in series between the power source end V and the grounding end G. For example, FIG. 2 shows that each second LED string 1031 comprises three or more second LEDs connected in series. The second LEDs have the second color temperature of, for example, 6500K.

In the first modification example, the first color temperature adjustment portion 1051 comprises one or more third LEDs D3 connected between the second LED string 1031 and the grounding end G on each of the second LED strings 1031. For example, FIG. 2 shows that two third LEDs D3 are connected in series between each second LED string 1031 of the two second LED strings 1031 and the grounding end G, but the present disclosure is not limited thereto; and the number of the third LEDs may be set as required. The third LEDs may have the second color temperature of, for example, 6500K.

Optionally, instead of the third LEDs, the first color temperature adjustment portion 1051 may comprise one or more first diodes or voltage regulator tubes connected between the second LED string 1031 and the grounding end G on each of the second LED strings 1031.

In the first modification example, the second manual switch assembly 1072 may comprise one or more second switches S2; for example, FIG. 2 shows that the second manual switch assembly 1072 comprises two second switches S2. However, the present disclosure is not limited thereto, and the number of the second switches may be set as required. Each of the second switches S2 is connected between the third LEDs and the grounding end G on each of the second LED strings 1031.

Optionally, when the third LEDs are replaced by the first diodes or voltage regulator tubes, each second switch S2 in the second manual switch assembly 1072 is connected between the first diodes or voltage regulator tubes and the grounding end G on each second LED string 1031.

FIG. 3 is a circuit diagram illustrating a second modification example of a color temperature-adjustable lamp device according to embodiments of the present disclosure.

The difference between the color temperature-adjustable lamp device in FIG. 3 and the color temperature-adjustable lamp device in FIG. 2 lies in the arrangements of the first manual switch assembly 1071, the first color temperature adjustment portion 1051 and the second manual switch assembly 1072, and the arrangements of the other components are the same as those in FIG. 2. In order to avoid obscuring the present disclosure by excessive illustration, hereinafter, regarding FIG. 3, only differences between same and FIG. 2 will be described, and for other same parts, reference can be made to the illustration of FIG. 2 for understanding.

In the second modification example, the first manual switch assembly 1071 comprises one first switch S1. The first switch S1 is connected between a first common node of the two or more first LED strings 1011 and the grounding end. For example, FIG. 3 shows that one switch S1 is connected between the first common node C1 of the two first LED strings 1011 and the grounding end G. Here, the first common node C1 is a common node of the two or more first LED strings 1011 between the voltage source end V and the grounding end G.

In the second modification example, the first color temperature adjustment portion 1051 comprises one or more third LEDs connected between a second common node of the two or more second LED strings 1031 and the grounding end. For example, as shown in FIG. 3, the first color temperature adjustment portion 1051 comprises two third LEDs, wherein the two third LEDs are connected between the second common node C2 of the two second LED strings 1031 and the grounding end G; however, the present disclosure is not limited thereto, and the number of the third LEDs may be set as required. Here, the second common node C2 is a common node of the two or more second LED strings 1031 between the voltage source end V and the grounding end G.

Optionally, instead of the third LEDs, the first color temperature adjustment portion 1051 may comprise one or more first diodes or voltage regulator tubes connected between the second common node C2 of the two or more second LED strings 1031 and the grounding end G.

In the second modification example, the second manual switch assembly 1072 comprises one second switch S2. For example, FIG. 3 shows that the second switch S2 is connected between the third LEDs and the grounding end G.

Optionally, when the third LEDs are replaced by the first diodes or the voltage regulator tubes, the second switch S2 is connected between the first diodes or the voltage regulator tubes and the grounding end G.

FIG. 4 is a circuit diagram illustrating a third modification example of a color temperature-adjustable lamp device according to embodiments of the present disclosure.

The difference between the color temperature-adjustable lamp device in FIG. 4 and the color temperature-adjustable lamp device in FIG. 2 lies in that the arrangement of a second color temperature adjustment portion, the arrangement of third switches and the arrangement of the fourth switches are newly added in FIG. 4; in addition, the arrangements of the other components in FIG. 4 are the same as those in FIG. 2. In order to avoid obscuring the present disclosure by excessive illustration, hereinafter, regarding FIG. 4, only differences between same and FIG. 2 will be described, and for other same parts, reference can be made to the illustration of FIG. 2 for understanding.

In the third modification example, the color temperature adjustment portion 105 further comprises a second color temperature adjustment portion 1052. The second color temperature adjustment portion 1052 is connected between the first LED lamp assembly 101 and the grounding end G. The second color temperature adjustment portion 1052 comprises one or more fourth LEDs D4 connected between each of the first LED strings 1011 and the grounding end G. For example, FIG. 4 shows that two fourth LEDs are connected in series between each first LED string 1011 of the two first LED strings 1011 and the grounding end G, but the present disclosure is not limited thereto; and the number of the fourth LEDs may be set as required. The fourth LEDs may have the first color temperature of, for example, 3000K.

Optionally, instead of the fourth LEDs, the second color temperature adjustment portion 1052 may comprise one or more second diodes or voltage regulator tubes connected between the first LED string 1011 and the grounding end G on each of the first LED strings 1011.

In the third modification example, the manual switch assembly 107 further comprises one or more third switches S3. For example, FIG. 4 shows that the manual switch assembly 107 further comprises two third switches S3, but the present disclosure is not limited thereto, and the number of the third switches can be set as required. Each of the third switches S3 is connected between the fourth LEDs and the grounding end G on each of the first LED strings 1011.

Optionally, when the fourth LEDs are replaced by the second diodes or voltage regulator tubes, each of the third switches S3 is connected between the second diodes or voltage regulator tubes and the grounding end G on each of the first LED strings 1011.

In the third modification example, the manual switch assembly 107 further comprises one or more fourth switches S4. For example, FIG. 4 shows that the manual switch assembly 107 further comprises two fourth switches S4, but the present disclosure is not limited thereto, and the number of the fourth switches can be set as required. Each of the fourth switches S4 is connected between a node C3 between the second LED string 1031 and the third LEDs and the grounding end G on each of the second LED strings 1031.

FIG. 5 is a circuit diagram illustrating a fourth modification example of a color temperature-adjustable lamp device according to embodiments of the present disclosure.

The difference between the color temperature-adjustable lamp device in FIG. 5 and the color temperature-adjustable lamp device in FIG. 3 lies in that the arrangement of a second color temperature adjustment portion, the arrangement of third switches and the arrangement of fourth switches are newly added in FIG. 5; in addition, the arrangements of the other components in FIG. 5 are the same as those in FIG. 3. In order to avoid obscuring the present disclosure by excessive illustration, hereinafter, regarding FIG. 5, only differences between same and FIG. 3 will be described, and for other same parts, reference can be made to the illustration of FIG. 3 for understanding.

In the fourth modification example, the color temperature adjustment portion 105 further comprises a second color temperature adjustment portion 1052. The second color temperature adjustment portion 1052 is connected between the first LED lamp assembly 101 and the grounding end G. The second color temperature adjustment portion 1052 comprises one or more fourth LEDs D4 connected between the first common node C1 of the two or more first LED strings 1011 and the grounding end G. For example, FIG. 5 shows that two fourth LEDs are connected in series between the first common node C1 of two first LED strings 1011 and the grounding end G, but the present disclosure is not limited thereto; and the number of the fourth LEDs may be set as required. The fourth LEDs may have the first color temperature of, for example, 3000K.

Optionally, instead of the fourth LEDs, the second color temperature adjustment portion 1052 may comprise one or more second diodes or voltage regulator tubes connected between the first common node C1 of the two or more first LED strings 1011 and the grounding end G.

In the fourth modification example, the manual switch assembly 107 further comprises one or more third switches S3. For example, FIG. 5 shows that one third switch S3 is connected between the fourth LEDs and the grounding end G.

Optionally, when the fourth LEDs are replaced by the second diodes or the voltage regulator tubes, the third switch S3 is connected between the second diodes or voltage regulator tubes and the grounding end G.

In the fourth modification example, the manual switch assembly 107 further comprises one fourth switch S4. For example, FIG. 5 shows that the fourth switch S4 is connected between the second common node C2 of the second LED strings 1031 and the grounding end G.

In the embodiments of the present disclosure, the illustration of each embodiment has its own emphasis. For the part not detailed in a certain embodiment, please refer to the relevant illustration in other embodiments.

In the color temperature-adjustable lamp device according to the present disclosure, by connecting the color temperature adjustment portion comprising at least one of a diode, an LED and a voltage regulator tube in series with LED lamp assemblies having different color temperatures of a lamp, and by controlling the turning-on and turning-off of the LED lamp assemblies by means of the manual switch assembly, adjustment of multiple color temperatures of the lamp device is achieved while avoiding significant heat dissipation risks in resistors due to the introduction of the resistors in the LED lamp assemblies. Moreover, when a non-resistor device is used as the temperature adjustment portion, for example, an LED, the generated power consumption is relatively small due to light emission of the LED, since the light is emitted from the LED instead of most heat energy is generated from a resistor, thereby increasing the photoelectric conversion efficiency.

The content above only relate to preferred embodiments of the present disclosure. It should be noted that for a person of ordinary skill in the art, several improvements and modifications can also be made without departing from the principle of the present disclosure, and these improvements and modifications shall also be considered as within the scope of protection of the present disclosure.

1. A color temperature-adjustable lamp device, comprising:
a first LED lamp assembly, having one or more LEDs, wherein light emitted by the first LED lamp assembly has a first color temperature;
a second LED lamp assembly, having LEDs, the number of which is the same as the number of the LEDs in the first LED lamp assembly, wherein light emitted by the second LED lamp assembly has a second color temperature, and the second color temperature is different from the first color temperature;
a color temperature adjustment portion, connected in series with at least one of the first LED lamp assembly and the second LED lamp assembly, the color temperature adjustment portion comprising at least one of a diode, an LED and a voltage regulator tube; and
a manual switch assembly, for controlling the turning-on and turning-off of the first LED lamp assembly and the second LED lamp assembly,
wherein after connecting the color temperature adjustment portion in series with at least one of the first LED lamp assembly and the second LED lamp assembly, a light-emitting assembly is formed together by a formed first lamp string where the first LED lamp assembly is located and a formed second lamp string where the second LED lamp assembly is located, and the light-emitting assembly is connected between a voltage source end and a grounding end.

2. The color temperature-adjustable lamp device according to claim 1, wherein the color temperature adjustment portion comprises:
a first color temperature adjustment portion, connected between the second LED lamp assembly and the grounding end.

3. The color temperature-adjustable lamp device according to claim 2, wherein the manual switch assembly comprises:
a first manual switch assembly, connected between the first LED lamp assembly and the grounding end; and
a second manual switch assembly, connected between the first color temperature adjustment portion and the grounding end.

4. The color temperature-adjustable lamp device according to claim 3, wherein
the first LED lamp assembly comprises one first LED string or two or more first LED strings connected in parallel, each of the first LED strings comprising one or more first LEDs connected in series between the voltage source end and the grounding end, the first LEDs having the first color temperature; and
the first manual switch assembly comprises one or more first switches, each of the first switches being connected between each of the first LED strings and the grounding end.

5. The color temperature-adjustable lamp device according to claim 4, wherein
the second LED lamp assembly comprises one second LED string or two or more second LED strings connected in parallel, each of the second LED strings comprising one or more second LEDs connected in series between the voltage source end and the grounding end, the second LEDs having the second color temperature;
the first color temperature adjustment portion comprises one or more third LEDs connected between the second LED string and the grounding end on each of the second LED strings; and
the second manual switch assembly comprises one or more second switches, and each of the second switches is connected between the third LEDs and the grounding end on each of the second LED strings.

6. The color temperature-adjustable lamp device according to claim 4, wherein
the second LED lamp assembly comprises one second LED string or two or more second LED strings connected in parallel, each of the second LED strings comprising one or more second LEDs connected in series between the voltage source end and the grounding end, the second LEDs having the second color temperature;
the first color temperature adjustment portion comprises one or more first diodes connected between the second LED string and the grounding end on each of the second LED strings; and
the second manual switch assembly comprises one or more second switches, and each of the second switches is connected between the first diodes and the grounding end on each of the second LED strings.

7. The color temperature-adjustable lamp device according to claim 3, wherein
the first LED lamp assembly comprises two or more first LED strings connected in parallel, each of the first LED strings comprising one or more first LEDs connected in series between the voltage source end and the grounding end, the first LEDs having the first color temperature; and
the first manual switch assembly comprises one first switch, wherein the first switch is connected between a first common node of the two or more first LED strings and the grounding end, and the first common node is located between the voltage source end and the grounding end.

8. The color temperature-adjustable lamp device according to claim 7, wherein
the second LED lamp assembly comprises two or more second LED strings connected in parallel, each of the second LED strings comprising one or more second LEDs connected in series between the voltage source end and the grounding end, the second LEDs having the second color temperature;
the first color temperature adjustment portion comprises one or more third LEDs connected between a second common node of the two or more second LED strings and the grounding end, wherein the second common node is located between the voltage source end and the grounding end; and
the second manual switch assembly comprises one second switch, the second switch being connected between the third LEDs and the grounding end.

9. The color temperature-adjustable lamp device according to claim 7, wherein
the second LED lamp assembly comprises two or more second LED strings connected in parallel, each of the second LED strings comprising one or more second LEDs connected in series between the voltage source end and the grounding end, the second LEDs having the second color temperature;
the first color temperature adjustment portion comprises one or more diodes connected between a second common node of the two or more second LED strings and the grounding end, wherein the second common node is located between the voltage source end and the grounding end; and
the second manual switch assembly comprises one second switch, the second switch being connected between the diodes and the grounding end.

10. The color temperature-adjustable lamp device according to claim 5, wherein the color temperature adjustment portion further comprises:
a second color temperature adjustment portion, connected between the first LED lamp assembly and the grounding end, the second color temperature adjustment portion comprising one or more fourth LEDs respectively connected between each of the first LED strings and the grounding end,
wherein the manual switch assembly further comprises one or more third switches, and each of the third switches is connected between the fourth LEDs and the grounding end on each of the first LED strings.

11. The color temperature-adjustable lamp device according to claim 5, wherein the color temperature adjustment portion further comprises:
a second color temperature adjustment portion, connected between the first LED lamp assembly and the grounding end, the second color temperature adjustment portion comprising one or more second diodes respectively connected between each of the first LED strings and the grounding end,
wherein the manual switch assembly further comprises one or more third switches, and each of the third switches is connected between the second diodes and the grounding end on each of the first LED strings.

12. The color temperature-adjustable lamp device according to claim 10, wherein the manual switch assembly further comprises one or more fourth switches, each of the fourth switches being connected between a node between the second LED string and the third LEDs and the grounding end on each of the second LED strings.

13. The color temperature-adjustable lamp device according to claim 8, wherein the color temperature adjustment portion further comprises:
a second color temperature adjustment portion, connected between the first LED lamp assembly and the grounding end, wherein the second color temperature adjustment portion comprises one or more fourth LEDs connected between the first common node of the two or more first LED strings and the grounding end, the fourth LEDs having the first color temperature,
wherein the manual switch assembly further comprises one third switch, the third switch being connected between the fourth LEDs and the grounding end.

14. The color temperature-adjustable lamp device according to claim 8, wherein the color temperature adjustment portion further comprises:
a second color temperature adjustment portion, connected between the first LED lamp assembly and the grounding end, wherein the second color temperature adjustment portion comprises one or more second diodes connected between the first common node of the two or more first LED strings and the grounding end,
wherein the manual switch assembly further comprises one third switch, the third switch being connected between the second diodes and the grounding end.

15. The color temperature-adjustable lamp device according to claim 13, wherein the manual switch assembly further comprises a fourth switch, the fourth switch being connected between the second common node of the second LED strings and the grounding end.
